(19) United States
(12) Patent Application Publication
(10) Pub. No.: US 2024/0310691 A1
(43) Pub. Date: Sep. 19, 2024

(54) OPTICAL PHASED ARRAY ACTIVELY RECONFIGURABLE APERTURE SHARING BY INTEGRATED OPTICAL SWITCH NETWORK

(71) Applicant: X DEVELOPMENT LLC, Mountain View, CA (US)

(72) Inventors: Paul Epp, Sunnyvale, CA (US); Devin Brinkley, Redwood City, CA (US); Andrei Kazmierski, Pleasanton, CA (US)

(73) Assignee: X DEVELOPMENT LLC, Mountain View, CA (US)

(21) Appl. No.: 18/586,677

(22) Filed: Feb. 26, 2024

Related U.S. Application Data
(60) Provisional application No. 63/490,539, filed on Mar. 16, 2023.

(51) Int. Cl. G02F 1/29; G02F 1/313; H01Q 3/26; H04B 10/11

(52) U.S. Cl. CPC G02F 1/292; G02F 1/3134; H01Q 3/2676; H04B 10/11

(57) ABSTRACT

Aspects of the disclosure provide an optical communications terminal comprising an optical phased array (OPA) photonic integrated chip comprising a plurality of phase shifters arranged in a plurality of segments; one or more additional phase shifters, a plurality of switches corresponding to each of the plurality of segments; and one or more splitters The optical communications terminal further comprising a full array transceiver configured to allow for transmission and receipt of optical communications beams functionality with the plurality of segments; and a plurality of segment transceivers each associated with one of the plurality of segments.

### CROSS-REFERENCE TO RELATED APPLICATIONS

This application claims the benefit of the filing date of U.S. Provisional Application No. 63/490,539, filed Mar. 16, 2023, the entire disclosure of which is incorporated by reference herein.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., MEMS or voice-coil based fast-steering mirror mechanisms) that are actuated to steer the beam. In other implementations, electro-optic steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electro-optic phase shifting capability.

### BRIEF SUMMARY

Aspects of the disclosure provide an optical communications terminal. The optical communications terminal comprising an optical phased array (OPA) photonic integrated chip. The OPA photonic integrated chip comprising a plurality of phase shifters arranged in a plurality of segments; one or more additional phase shifters, a plurality of switches corresponding to each of the plurality of segments; and one or more splitters. The optical communications terminal further includes a full array transceiver configured to allow for transmission and receipt of optical communications beams functionality with the plurality of segments; and a plurality of segment transceivers each associated with one of the plurality of segments.

In one example the optical communications terminal further includes one or more paths extending from one or more of the full array transceivers and the plurality of the segment transceivers to the plurality of segments.

In a further example, the one or more paths include a plurality of full array paths and a plurality of segment paths, the plurality of full array paths extending from the full array transceiver to each of the plurality of segments, and the plurality of segment paths extending from each of the plurality of segment transceivers to each corresponding segment of the plurality of segments.

In a further example, the one or more additional phase shifters are disposed in at least one of the plurality of full array paths. In another example, the one or more splitters are disposed in at least one of the plurality of full array paths. In another example, the plurality of switches are disposed in one of the plurality of full array paths and one of the plurality of segment paths.

In another example, each of the plurality of segments includes a waveguide configuration. The waveguide configuration comprising one or more combiners; and an edge coupler; wherein the one or more combiners and edge coupler are connected via waveguides.

Another aspect of the disclosure provides a method of transmitting one or more optical communications beams. The method comprising driving, by one or more processors of a first optical communications terminal, a plurality of phase shifters arranged in a plurality of segments; placing a plurality of switches in one of i) a first position or ii) a second position, wherein the first position allows for joint functionality of the plurality of segments and wherein the second position allows for independent functionality of the plurality of segments; directing power of the one or more optical communications beams along one or more paths extending from a plurality of transceivers to the plurality of segments; and transmitting, by the one or more processors, the one or more optical communications beams via one or more of the plurality of transceivers.

In one example, placing a plurality of switches in one of i) the first position or ii) the second position is conducted during setup of the first optical communications terminal.

In another example, placing a plurality of switches in one of i) the first position or ii) the second position is conducted following receipt of one or more beacon signals from one or more remote optical communications terminals.

In another example, the method further includes determining, by the one or more processors, a desired pointing direction for the one or more optical communications beams based on one or more locations corresponding to one or more remote devices.

In a further example, the one or more locations of the one or more remote devices are provided predefined locations.

In another example, the method further includes determining the one or more locations of the one or more remote devices based on characteristics of one or more received from the one or more remote devices during acquisition.

In one example, the plurality of switches are placed in the first position; the plurality of transceivers includes a full array transceiver configured to allow for transmission of optical communications beams functionality with the plurality of segments; the one or more paths include a plurality of full array paths, the plurality of full array paths extending from the full array transceiver to each of the plurality of segments; and directing power of the one or more optical communications beams along one or more paths extending from a plurality of transceivers to the plurality of segments includes dividing power along the plurality of full array paths using one or more splitters.

In a further example, transmitting, by the one or more processors, the one or more optical communications beams via one or more of the plurality of transceivers includes transmitting, by the one or more processors, the one or more optical communications beams via the full array transceiver.

In one example, the plurality of switches are placed in the second position; the plurality of transceivers includes a plurality of segment transceivers each associated with one of the plurality of segments; the one or more paths include a plurality of segment paths, the plurality of segment paths extending from each of the plurality of segment transceivers to each corresponding segment of the plurality of segments; and directing power of the one or more optical communications beams along one or more paths extending from a plurality of transceivers to the plurality of segments includes directing power along the plurality of segment paths.

In a further example transmitting, by the one or more processors, the one or more optical communications beams via one or more of the plurality of transceivers includes transmitting, by the one or more processors, the one or more optical communications beams via one or more of the plurality of segment transceivers.

Another aspect of the disclosure provides a method of receiving one or more optical communications beams. The method comprising driving, by one or more processors of a first optical communications terminal, a plurality of phase shifters arranged in a plurality of segments; placing, by the one or more processors, a plurality of switches in one of i) a first position or ii) a second position, wherein the first position allows for joint functionality of the plurality of segments and wherein the second position allows for independent functionality of the plurality of segments; directing power of the one or more optical communications beams along one or more paths extending from a plurality of transceivers to the plurality of segments; and receiving, by the one or more processors, the one or more optical communications beams via one or more of the plurality of transceivers.

In one example, placing a plurality of switches in one of i) the first position or ii) the second position is conducted during setup of the first optical communications terminal.

In another example, placing a plurality of switches in one of i) the first position or ii) the second position is conducted following receipt of one or more beacon signals from one or more remote optical communications terminals.

In another example, the plurality of switches are placed in the first position; the plurality of transceivers includes a full array transceiver configured to allow for receipt of optical communications beams functionality with the plurality of segments; the one or more paths include a plurality of full array paths, the plurality of full array paths extending from the full array transceiver to each of the plurality of segments; and directing power of the one or more optical communications beams along one or more paths extending from a plurality of transceivers to the plurality of segments includes combining power along the plurality of full array paths using one or more splitters, adjusting a phase of at least one portion of the one or more optical communications beams along at least one of the plurality of full array paths using on or more additional phase shifters.

In a further example, receiving, by the one or more processors, the one or more optical communications beams via one or more of the plurality of transceivers includes receiving, by the one or more processors, the one or more optical communications beams via the full array transceiver.

In another example, the plurality of switches are placed in the second position; the plurality of transceivers includes a plurality of segment transceivers each associated with one of the plurality of segments; the one or more paths include a plurality of segment paths, the plurality of segment paths extending from each of the plurality of segment transceivers to each corresponding segments of the plurality of segments; and directing power of the one or more optical communications beams along one or more paths extending from a plurality of transceivers to the plurality of segments includes directing power along the plurality of segment paths.

In a further example, receiving, by the one or more processors, the one or more optical communications beams via one or more of the plurality of transceivers includes receiving, by the one or more processors, the one or more optical communications beams via one or more of the plurality of segment transceivers.

### BRIEF DESCRIPTION OF THE DRAWINGS

FIG. 1 is a block diagram 100 of a first optical communications terminal and a second optical communications terminal in accordance with aspects of the disclosure.

FIG. 2 is a pictorial diagram 200 of an example system architecture for the first communication terminal of FIG. 1 in accordance with aspects of the disclosure.

FIG. 3 represents features of an OPA architecture represented as an example OPA chip in accordance with aspects of the disclosure.

FIG. 4 is a pictorial diagram of a network in accordance with aspects of the disclosure.

FIG. 5 illustrates an example optical communications terminal in accordance with aspects of the disclosure.

FIG. 6 is a flow diagram in accordance with aspects of the disclosure.

FIG. 7 is a flow diagram in accordance with aspects of the disclosure.

FIG. 8 is a flow diagram in accordance with aspects of the disclosure.

FIG. 9 is a flow diagram in accordance with aspects of the disclosure.

### DETAILED DESCRIPTION

### Overview

The technology relates to an optical phased array (OPA) architecture for an optical communications terminal that may be steered in a direction of a plurality of remote optical communications terminals simultaneously. The OPA architecture may involve the use of a single OPA chip with a plurality of photonic integrated circuits (PIC). In this regard, the OPA architecture may include a plurality of segments (“a segmented OPA architecture”). This OPA architecture may enable simultaneous transmit and receive functions with a plurality of remote optical communications terminals.

Generally, transmitting (Tx) and receiving (Rx) optical communications beams from a remote optical communications terminal may include steering an OPA architecture of a first optical communications terminal to adjust a pointing direction and/or wavefront shape. However, while steering the OPA may allow for alignment between the first optical communications terminal and a single remote optical communications terminal, doing so with a plurality of optical communications terminals at different locations at the same time is not feasible. In other words, to communicate with multiple remote optical communications terminals, the first optical communications terminal may be steered each time it communicates with a different remote optical communications terminal. In this regard, to maintain continuous connectivity among a plurality of communications terminals, an optical communications system may require significant numbers of optical communications terminals. At the same time, additional terminals may require extra materials and may be more costly to maintain.

To address this, as noted above, the first optical communications terminal may include a segmented OPA architecture to allow the first optical communications terminal to be aligned with one or more remote optical combinations terminals or a plurality of remote optical communications terminals simultaneously.

As noted above, the segmented OPA architecture of the first optical communications terminal may contain a plurality of segments. Each of these segments may include a PIC with a plurality of features including a micro-lens array, an emitter associated with each micro-lens, a set of phase shifters for each micro-lens, an emitter for each micro-lens, and waveguides that connect the components in the OPA architecture. A plurality of splitters, and phase shifters may be used to control whether the plurality of segments function independently or in conjunction with one another.

The plurality of switches may be configured to be in a first or second position. The first position may allow for Tx/Rx joint functionality with other segments of the segmented OPA architecture, whereas the second position may allow for Tx/Rx functionality independent of other segments of the segmented OPA architecture.

The first optical communications terminal may contain a plurality of transceivers. One of the plurality of transceivers may be a full array transceiver configured to allow for Tx/Rx functionality with all segments of the plurality of segments, whereas the remaining transceivers may be segment transceivers configured to allow for Tx/Rx functionality with a single segment of the plurality of segments. In addition to the full array transceiver, the plurality of transceivers may include a plurality of segment transceivers, each connected to one of the plurality of switches via waveguides or optical fibers. In this regard, the plurality of segment transceivers may transmit and receive optical communications beams from corresponding segments of the plurality of segments when the corresponding switch is in the second position. Moreover, the full array transceiver may be used to transmit and receive optical communications beams from the plurality of segments when the plurality of switches are in the first position. A plurality of full array paths may be defined as extending from the full array transceiver to each of the plurality of segments. A plurality of segment paths may be defined as extending from each of the plurality of segment transceivers, to each of the corresponding segments.

The segmented OPA architecture may contain one or more additional phase shifters and one or more splitters (e.g., 1×2 splitter) in full array paths from a respective one of the array of phase shifters to the full array transceiver. In some implementations, each of the one or more additional phase shifters may be disposed in a respective full array path between the plurality of switches and the full array transceiver. Additionally or alternatively, the additional phase shifters may be disposed in a respective full array path or segment path between each of the respective array of phase shifters and a corresponding switch of the plurality of switches. The segmented OPA architecture contains three additional phase shifters (i.e., a first additional phase shifter, second additional phase shifter, and third additional phase shifter.)

Each segment may be aligned with or steered in a direction of a plurality of remote optical communications terminals simulations. In this regard, each segment of the segmented OPA architecture may be individually driven to point in a different pointing direction corresponding to remote optical communications terminals. For instance, the individual segments of the segmented OPA architecture may receive and transmit optical communications beams from differing remote terminals at differing times or simultaneously. Additionally, each segment may be driven in conjunction with one or more of the other segments of the segmented OPA architecture to transmit and receive optical communications beams from the same remote optical communications terminal.

### Example Systems

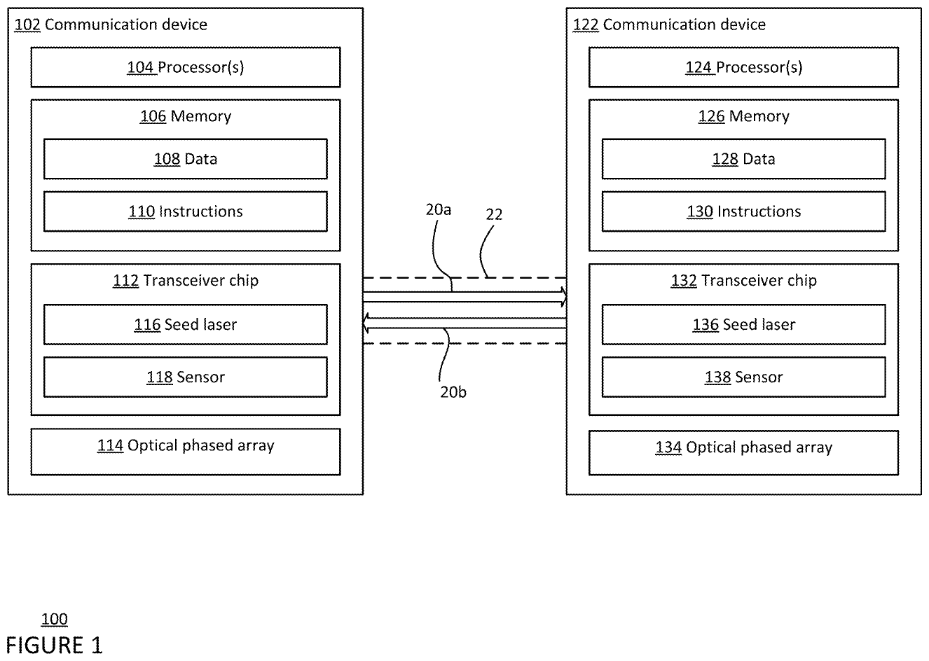

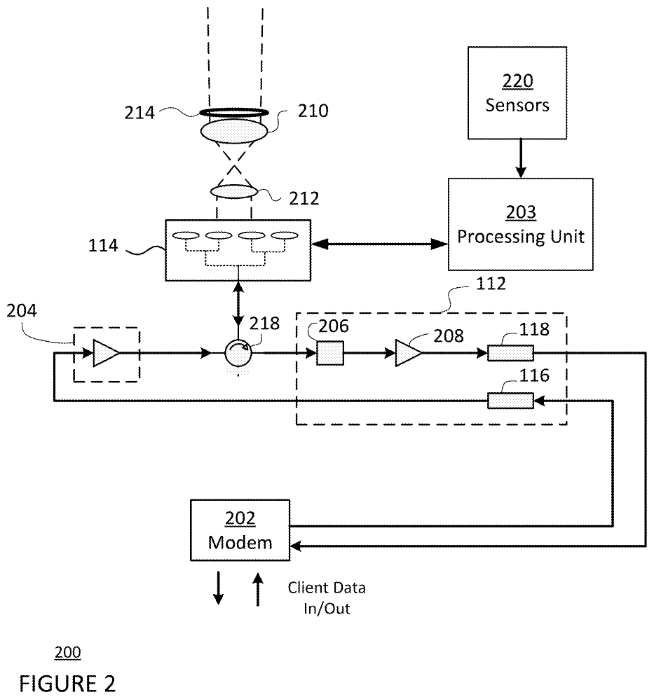

FIG. 1 is a block diagram 100 of a first optical communications terminal configured to form one or more links with a second optical communications terminal, for instance as part of a system such as a free-space optical communication (FSOC) system. FIG. 2 is a pictorial diagram 200 of an example communications terminal, such as the first optical communications terminal of FIG. 1. For example, a first optical communications terminal 102 includes one or more processors 104, a memory 106, a transceiver photonic integrated chip 112, and an optical phased array (OPA) architecture 114. In some implementations, the first optical communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture 114 may include a micro-lens array, an emitter associated with each micro-lens in the array, a plurality of phase shifters, and waveguides that connect the components in the OPA. The OPA architecture may be positioned on a single chip, an OPA chip. The waveguides progressively merge between a plurality of emitters and an edge coupler that connect to other transmitter and/or receiver components. In this regard, the waveguides may direct light between photodetectors or fiber outside of the OPA architecture, the phase shifters, the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA architecture 114 may receive light from the transmitter components and outputs the light as a coherent communications beam to be received by a remote communications terminal or client device, such as second optical communications terminal 122. The OPA architecture 114 may also receive light from free space, such as a communications beam from second optical communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first optical communications terminal 102 may include additional components to support functions of the communications terminal. For example, the first optical communications terminal may include one or more lenses and/or mirrors that form a telescope. The telescope may receive collimated light and output collimated light. The telescope may include an objective portion, an eyepiece portion, and a relay portion. As shown in FIG. 2, the first optical communications terminal may include a telescope including an objective lens 210, an eyepiece lens 212, and an aperture 214 (or opening) through which light may enter and exit the communications terminal. For ease of representation and understanding, the aperture 214 is depicted as distinct from the objective lens 210, though the objective lens 210 may be positioned within the aperture. The first optical communications terminal may include a circulator or wavelength splitter, such as a single mode circulator 218, that routes incoming light and outgoing light while keeping them on at least partially separate paths. The first optical communications terminal may include one or more sensors 220 for detecting measurements of environmental features and/or system components.

The first optical communications terminal 102 may include one or more steering mechanisms, such as one or more bias means for controlling one or more phase shifters, which may be part of the OPA architecture 114, and/or an actuated/steering mirror (not shown), such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first optical communications terminal also includes optical fibers or waveguides connecting optical components, creating a path between the seed laser 116 and OPA architecture 114 and a path between the OPA architecture 114 and the sensor 118.

Returning to FIG. 1, the second optical communications terminal 122 may output the Tx signals as an optical communications beam 20b (e.g., light) pointed towards the first optical communications terminal 102, which receives the optical communications beam 20b (e.g., light) as corresponding Rx signals. In this regard, the second optical communications terminal 122 includes one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second optical communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second optical communications terminal 122 may be included similar to the additional components described above. The second optical communications terminal 122 may have a system architecture that is same or similar to the system architecture shown in FIG. 2.

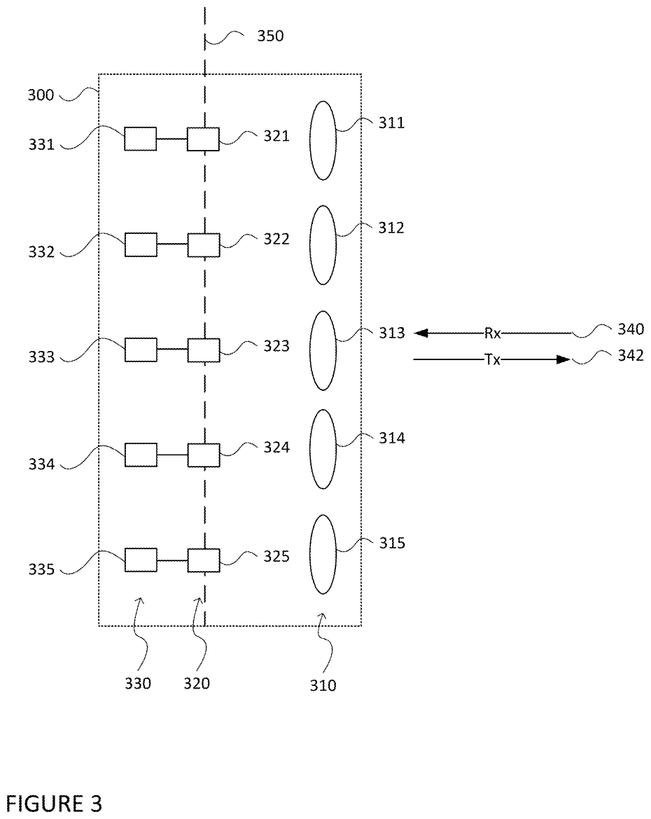

FIG. 3 represent features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 represent the general direction of Tx signals (transmitted optical communications beam) and Rx signals (received optical communications beam) as such signals pass or travel through the OPA chip 300.

The micro-lens array 310 may include a plurality of convex micro-lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10's to 1000's of micrometers in diameter and height. In addition, each micro-lens of the micro-lens array may be manufactured by molding, printing, or etching a lens directly into a wafer of the OPA chip 300. Alternatively, the micro-lens array 310 may be molded, printed, or etched as a separately fabricated micro-lens array. In this example, the micro-lens array 310 may be a rectangular or square plate of glass or silica a few mm (e.g., 10 mm or more or less) in length and width and 0.2 mm or more or less thick. Integrating the micro-lens array within the OPA chip 300 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 320. For example, each micro-lens may have an emitter from which Tx signals are received and to which the Rx signals are focused. As an example, micro-lens 311 is associated with emitter 321. Similarly, each micro-lens 312-315 also has a respective emitter 322-325. In this regard, for a given pitch (i.e., edge length of a micro-lens) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the Tx signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 330 may allow for sensing and measuring Rx signals and the altering of Tx signals to improve signal strength optimally combining an input wavefront into a single waveguide or fiber. Each emitter may be associated with a phase shifter. As shown in FIG. 3, each emitter may be connected to a respective phase shifter. As an example, the emitter 320 is associated with a phase shifter 330. The Rx signals received at the phase shifters 331-335 may be provided to receiver components including the sensor 118, and the Tx signals from the phase shifters 331-335 may be provided to the respective emitters of the plurality of emitters 320. The architecture for the plurality of phase shifters 330 may include at least one layer of phase shifters having at least one phase shifter connected to an emitter of the plurality of emitters 320. In some examples, the phase shifter architecture may include a plurality of layers of phase shifters, where phase shifters in a first layer may be connected in series with one or more phase shifters in a second layer.

A communication link 22 may be formed between the first optical communications terminal 102 and the second optical communications terminal 122 when the transceivers of the first and second optical communications terminals are aligned. The alignment can be determined using the optical communications beams 20a, 20b to determine when line-of-sight is established between the communications terminals 102, 122. Using the communication link 22, the one or more processors 104 can send communication signals using the optical communications beam 20a to the second optical communications terminal 122 through free space, and the one or more processors 124 can send communication signals using the optical communications beam 20b to the first optical communications terminal 102 through free space. The communication link 22 between the first and second optical communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

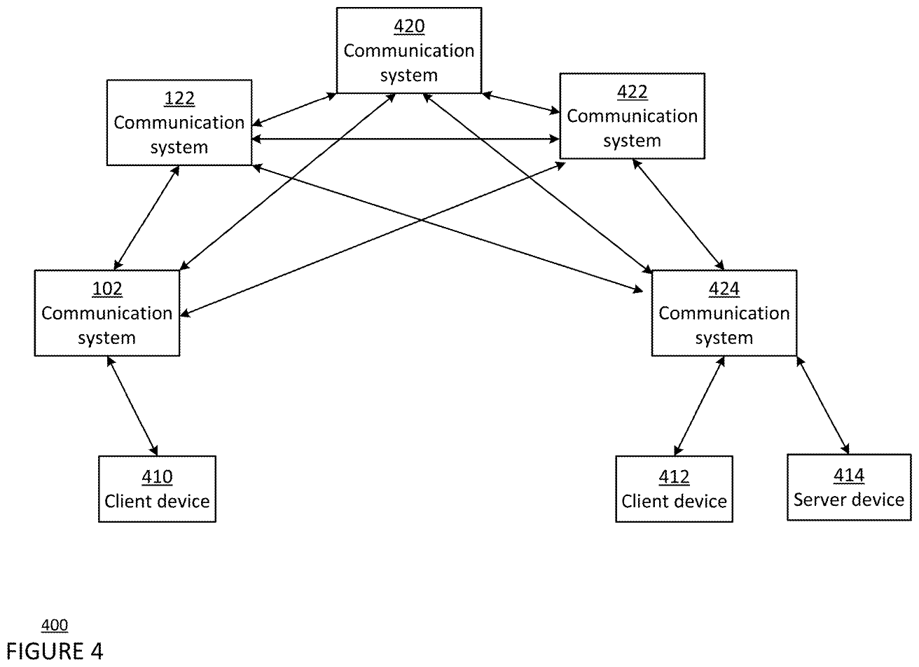

As shown in FIG. 4, a plurality of communications terminals, such as the first optical communications terminal 102 and the second optical communications terminal 122, may be configured to form a plurality of communication links (illustrated as arrows) between a plurality of communications terminals, thereby forming a network 400. The network 400 may include client devices 410 and 412, server device 414, and communications terminals 102, 122, 420, 422, and 424. Each of the client devices 410, 412, server device 414, and communications terminals 420, 422, and 424 may include one or more processors, a memory, a transceiver chip, and an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the first optical communications terminal 102 is shown having communication links with client device 410 and communications terminals 122, 420, and 422. The second optical communications terminal 122 is shown having communication links with communications terminals 102, 420, 422, and 424.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of moveable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

As noted above, the OPA architecture of the first optical communications terminal 102 may be a segmented OPA architecture containing a plurality of segments. Each of these segments may include a PIC with a plurality of features including a micro-lens array, an emitter associated with each micro-lens, a set of phase shifters for each micro-lens, an emitter for each micro-lens, waveguides that connect the components in the OPA architecture, and one or more combiners that may combine connected waveguides. A plurality of splitters, phase shifters, and switches may be used to control whether the plurality of segments function independently or in conjunction with one another.

In one example, the plurality of segments may include 2, 4 or more or less segments. Each segment may be configured to send and receive communications independently and with all of the other segments at different times. For instance, the first optical communications terminal 102 may communicate with two or more remote optical communications terminals or client devices. In this scenario, one segment of the plurality of segments may be configured to transmit and receive optical communications beams for one of the two remote optical communications terminals while another the plurality of segments of the segmented OPA architecture may be configured to transmit and receive optical communications beams with the other of the two remote optical communications terminals. Using the plurality of switches and splitters, the segments may be configured to send and receive communications to the same remote communications terminal at once.

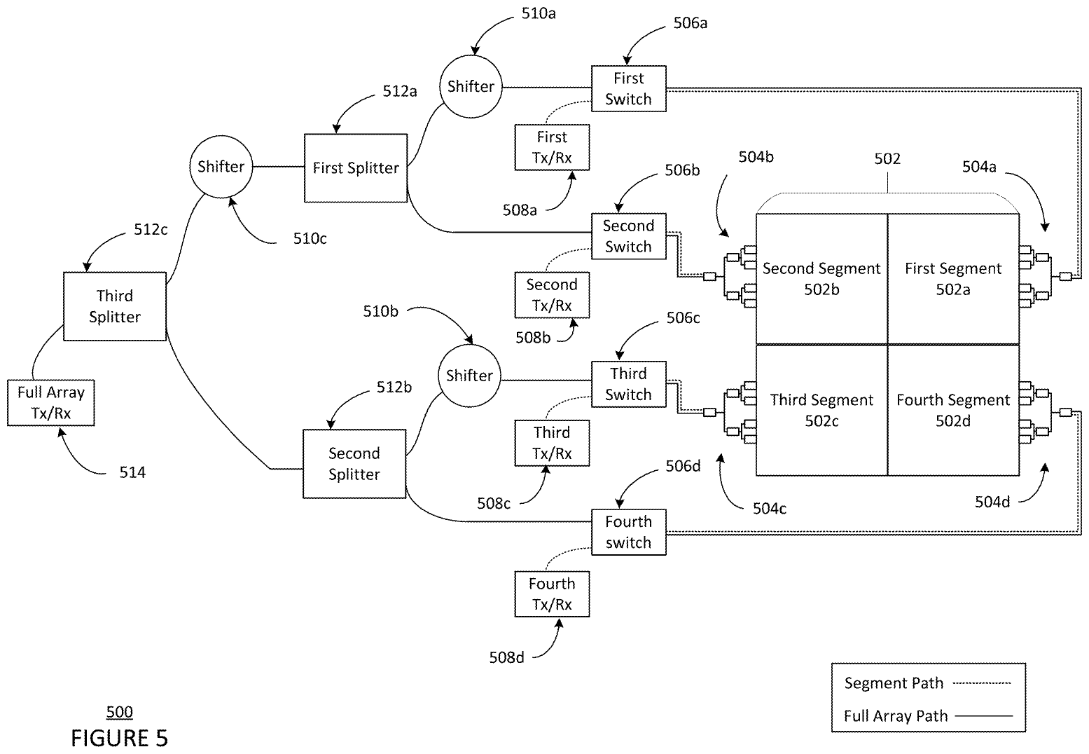

FIG. 5 illustrates an example system architecture 500 for the first optical communications terminal 102 including a PIC with a segmented OPA architecture. The example system architecture 500 includes a segmented OPA 502 with a plurality of segments, here four segments (i.e., a first segment 502a, second segment 502b, third segment 502c, and fourth segment 502d). Each of the segments 502a, 502b, 502c, 502d, may include a waveguide configuration 504a, 504b, 504c, 504d which may include one or more combiners and an edge coupler. In particular, the waveguide configuration 504a, 504b, 504c, 504d may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler. Each of the plurality of segments 502a, 502b, 502c, 502d includes a respective plurality of phase shifters. Each of the plurality of segments 502a, 502b, 502c, 502d is connected via optical fibers or waveguides to a switch. In this regard, the segmented OPA includes a switch for each segment of the plurality of segments, here four switches (i.e., a first switch 506a, second switch 506b, third switch 506c, and fourth switch 506d).

The plurality of switches 506a, 506b, 506c, 506d may be configured to be in a first or second position. The first position may allow for Tx/Rx joint functionality with other segments of the segmented OPA architecture, whereas the second position may allow for Tx/Rx functionality independent of other segments of the segmented OPA architecture.

The first optical communications terminal 102 may contain a plurality of transceivers. One of the plurality of transceivers may be a full array transceiver 514 configured to allow for Tx/Rx functionality with all segments of the plurality of segments, whereas the remaining transceivers may be a plurality of segment transceivers configured to allow for Tx/Rx functionality with a single segment of the plurality of segments. FIG. 5 illustrates a first segment transceiver 508a corresponding to the first segment 502a, a second segment transceiver 508b corresponding to the second segment 502b, a third transceiver 508c corresponding to the third segment 502c, and a fourth segment transceiver 508d corresponding to the fourth segment 502d. The plurality of segment transceivers 508a, 508b, 508c, 508d may each be connected to one of the plurality of switches 506a, 506b, 506c, 506d via waveguides or optical fibers. In this regard, the plurality of segment transceivers 508a, 508b, 508c, 508d may transmit and receive optical communications beams from corresponding segments of the plurality of segments when the corresponding switch is in the second position. Moreover, the full array transceiver 514 may be used to transmit and receive optical communications beams from the plurality of segments when the plurality of switches are all in the first position. A plurality of full array paths may be defined as extending from the full array transceiver to each of the plurality of segments. A plurality of segment paths may be defined as extending from each of the plurality of segment transceivers, to each of the corresponding segments.

The segmented OPA architecture may contain one or more additional phase shifters 510a, 510b, 510c and one or more splitters (e.g., 1×2 splitter) 512a, 512b, 512c in full array paths from a respective one of the array of phase shifters to the full array transceiver 514. In some implementations and as illustrated in FIG. 5, each of the one or more additional phase shifters 510a, 510b, 510c may be disposed in a respective full array path between the plurality of switches 506a, 506b, 506c, 506d and the full array transceiver 514. Additionally or alternatively, the additional phase shifters 510a, 510b, 510c may be disposed in a respective full array path or segment path between each of the respective array of phase shifters and a corresponding switch of the plurality of switches. As shown in FIG. 5, the segmented OPA architecture contains three additional phase shifters (i.e., a first additional phase shifter 510a, second additional phase shifter 510b, and third additional phase shifter 510c.)

For instance, as shown in FIG. 5, the segmented OPA architecture may include one or more splitters. The one or more splitters enable division (e.g., splitting) and combination of power along a plurality of different full array paths. The full array paths may extend from the segments to the full array transceiver 514. In FIG. 5, the example segmented OPA architecture includes three splitters disposed in the four full array paths from four segments to a full array transceiver. For instance, a first splitter 512a is disposed in a first full array path and the second full array path. The first full array path extending from the first segment 502a to the full array transceiver 514 and the second full array path extending from the second segment 502b to the full array transceiver 514.

In a receive direction, the first splitter 512a may combine the first full array path and second full array path and in the transmit direction, the first splitter 512a may divide the first full array path and second full array path. In this regard, the first splitter 512a connects with an optical fiber or waveguide of the first full array path and an optical fiber or waveguide of the second full array path on the segment side and connects with a joint first and second full array path optical fiber or waveguide on the full array transceiver side.

The first splitter 512a may combine and divide power along the first full array path and the second full array path when the first segment 502a and second segment 502b function jointly. For example, if the first segment 502a and the second segment 502b function jointly (i.e., driven together to transmit and receive optical communications beams) the first splitter 512a may combine power when an optical communications beam is received and may divide power equally when an optical communications beam is transmitted. If the first segment 502a and second segment 502b do not function jointly, the first splitter 512a may not divide or combine power along the first full array path and the second full array path.

FIG. 5 further illustrates a second splitter 512b is disposed in a third full array path and a fourth full array path. The third full array path extending from a third segment 502c to the full array transceiver 514 and the fourth full array path extending from a fourth segment 502d to the full array transceiver 514.

In a receive direction, the second splitter 512b may combine the third full array path and fourth full array path and in the transmit direction, the second splitter 512b may divide the third full array path and fourth full array path. In this regard, the second splitter 512b connects with an optical fiber or waveguide of the third full array path and an optical fiber or waveguide of the fourth full array path on the segment side and connects with a joint third and fourth full array path optical fiber or waveguide on the full array transceiver side. Similar to the first splitter 512a, the second splitter 512b may combine and divide power along different full array paths when the third segment 502c and fourth segment 502d function jointly.

FIG. 5 further illustrates a third splitter 512c disposed in the first full array path, second full array path, third full array path, and fourth full array path. In a receive direction, the third splitter 512c may combine the joint first and second full array path and the joint the third full array path and fourth full array path and in the transmit direction, the third splitter 512c may divide the joint first full array path, second full array path, third full array path, and fourth full array path into the joint first and second full array path and the joint the third full array path and fourth full array path. In this regard, the third splitter 512c connects with the joint first and second full array path optical fiber or waveguide and the joint third and fourth full array path optical fiber or waveguide the joint first and second full array path on the segment side and connects with a joint first, second, third, and fourth full array path optical fiber or waveguide on the full array transceiver side. The third splitter 512c may combine and divide power along different full array paths when the first segment 502a, second segment 502b, the third segment 502c, and the fourth segment 502d function jointly.

In this regard, the undivided and uncombined power may be directed along the full array path of the one or more segments transmitting or receiving optical communications beams via the full array transceiver 514 (e.g., towards the first splitter or towards the second splitter).

### Example Methods

Each segment of the segmented OPA architecture may be aligned with or steered in a direction of a plurality of remote optical communications terminals. In this regard, each segment of the segmented OPA architecture may be individually driven to point in a different pointing direction corresponding to remote optical communications terminals. For instance, the individual segments of the segmented OPA architecture may receive and transmit optical communications beams from differing remote terminals at differing times or simultaneously. Additionally, each segment may be driven in conjunction with one or more of the other segments of the segmented OPA architecture to transmit and receive optical communications beams from the same remote optical communications terminal.

In one scenario, all of the plurality of segments of the segmented OPA architecture may function in conjunction to transmit and receive optical communications beams with a remote optical communications terminal. For instance, the plurality of segments may function in conjunction to transmit one or more optical communications beams to a remote optical communications terminal. In this instance, light moves through the segments of the segmented OPA architecture in a transmit direction. In the transmit direction, light may be directed into each of the segments from a transceiver (e.g., the full array transceiver or one of the plurality of segment transceivers).

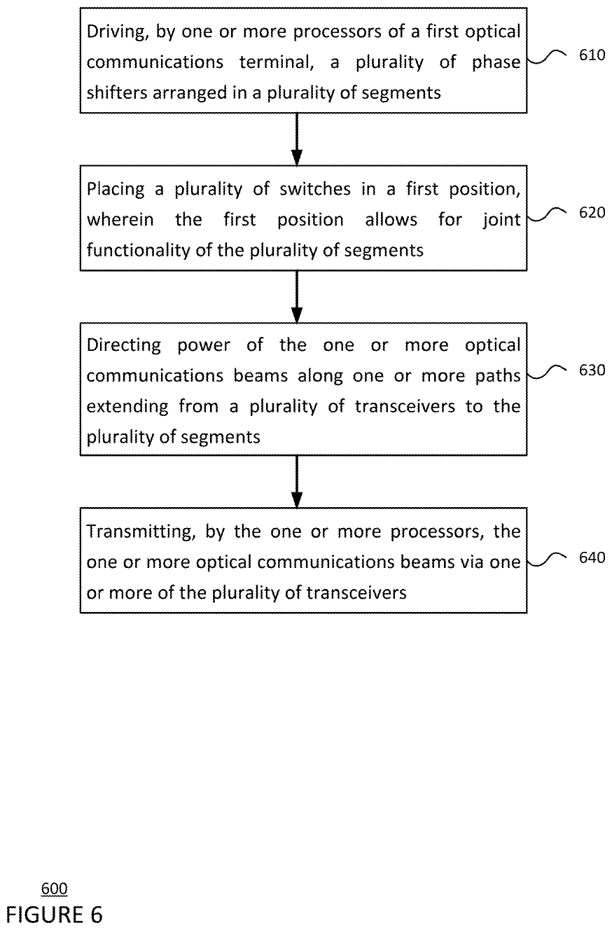

FIG. 6 illustrates an example method 600 of transmitting one or more optical communications beams. For example, at block 610, the plurality of phase shifters of the plurality of segments may be driven by one or more processors of a first optical communications terminal. In this regard, the one or more processors 104 of the first optical communications terminal 102 may jointly drive the plurality of segments 502a, 502b, 502c, 502d. The plurality of segments 502a, 502b, 502c, 502d may be driven to achieve a desired pointing direction for the one or more optical communications beams 20a. In this regard, the one or more processors 104 may calculate a phase shift for each segment of the segmented OPA architecture to achieve a desired pointing direction for the one or more optical communications beams 20a. For instance, the one or more processors 104 may determine a shift for each phase shifter in each of the plurality of segments 502a, 502b, 502c, 502d of the segmented OPA architecture based on the desired pointing direction.

The one or more processors 104 may determine a desired pointing direction for the one or more optical communications beams 20a based on a location of the remote optical communications terminal (e.g., client device or the second optical communications terminal 122) relative to the position of the aperture 214 of the first optical communications terminal 102. For example, the desired pointing direction may be an angular value such as 2 degrees, −5 degrees, etc. from an axis of the aperture 214 of the first optical communications terminal. In some implementations, the location of the remote optical communications terminal may be a predefined location that can be provided during setup of the communications system.

Additionally or alternatively, the one or more processors of the first optical communications terminal 102, may predict or determine the location of the remote optical communications terminal based on characteristics of one or more signals (e.g., beacon signal) received from the remote optical communications terminal during acquisition. The one or more processors 104 may receive the one or more signals while conducting a raster-scan across the field of regard (FOR) of the first optical communications terminal 102. The raster-scan may consist of signal (e.g., beacon signal) sweeps across rows of the FOR. The FOR may be the area that may be observed across the full steering range of an optical communications terminal. In this regard, the terminals of the optical communications system may coordinate acquisition and broadcasting states such that the first optical communications terminal 102 may receive one or more signals from the remote optical communications terminal.

In one example, the signal received from the remote optical communications terminal may be a beacon signal from a raster-scan of the remote optical communications terminal. In another example, the signal received from the remote optical communications terminal may be a divergent beam covering the FOR of the remote optical communication terminal.

As shown at block 620, the method 600 may further include placing the plurality of switches in a first position, the first position allowing for joint functionality of the plurality of segments. In such an instance, the one or more processors 104 of the first optical communications terminal 102 may place the plurality of switches 506a, 506b, 506c, 506d in the first position upon receipt of one or more beacon signals from the remote optical communications terminal. Additionally or alternatively, a human operator at setup may place the plurality of switches 506a, 506b, 506c, 506d in the first position. When the plurality of switches 506a, 506b, 506c, 506d are in a first position, the plurality of segments 502a, 502b, 502c, 502d may function in conjunction or jointly (i.e., be driven together to transmit and receive optical communications beams). For instance, referring to FIG. 5, when the first switch 506a, second switch 506b, third switch 506c, and fourth switch 506d may be placed in the first position, the first segment 502a, second segment 502b, third segment 502c, and fourth segment 502d function jointly.

As shown at block 630, the method 600 may further include directing power of the one or more optical communications beams along one or paths extending from the plurality of transceivers to the plurality of segments. In this scenario, power of the one or more optical communications beams 20a may be divided along a plurality of full array paths from a full array transmitter to the plurality of the plurality of segments 502a, 502b, 502c, 502d via the one or more splitters. For instance, referring to FIG. 5, the third splitter 512c is disposed in the first full array path, second full array path, third full array path, and fourth full array path. In the transmit direction, the third splitter 512c may divide the joint first, second, third, and fourth full array path evenly into a joint first and second full array path and a joint third and fourth full array path. In this regard, half of the power may be directed into the joint first and second full array path and half of the power may be directed into the joint third and fourth full array path.

In addition, the first splitter 512a is disposed in the first full array path and the second full array path. In the transmit direction, the first splitter 512a may evenly divide the power of the joint first and second full array path into the first full array path and the second full array path. In this regard, a fourth of the power may be directed into the first full array path and a fourth of the power may be directed into the second full array path.

In addition, the second splitter 512b is disposed in the third full array path and the fourth full array path. In the transmit direction, the second splitter 512b may evenly divide the joint third and fourth full array path into the third full array path and the fourth full array path. In this regard, a fourth of the power may be directed into the third full array path and a fourth of the power may be directed into the fourth full array path.

At block 640, the method 600 may further include transmitting, by the one or more processors, the one or more optical communications beams via one or more of the plurality of transceivers. The one or more processors 104 of the first optical communications terminal 102 may transmit the one or more optical communications beams 20a via all of the plurality of segments 502a, 502b, 502c, 502d of the OPA at once or rather via the full array transceiver. For instance, referring to FIG. 5, the first segment 502a, the second segment 502b, the third segment 502c, and the fourth segment 502d may be used to transmit one or more optical communications beams 20a via the full array transceiver 514. Using the one or more optical communication beams, the one or more processors may establish a communication link with the remote optical communications terminal in order to send communications, transfer data, etc.

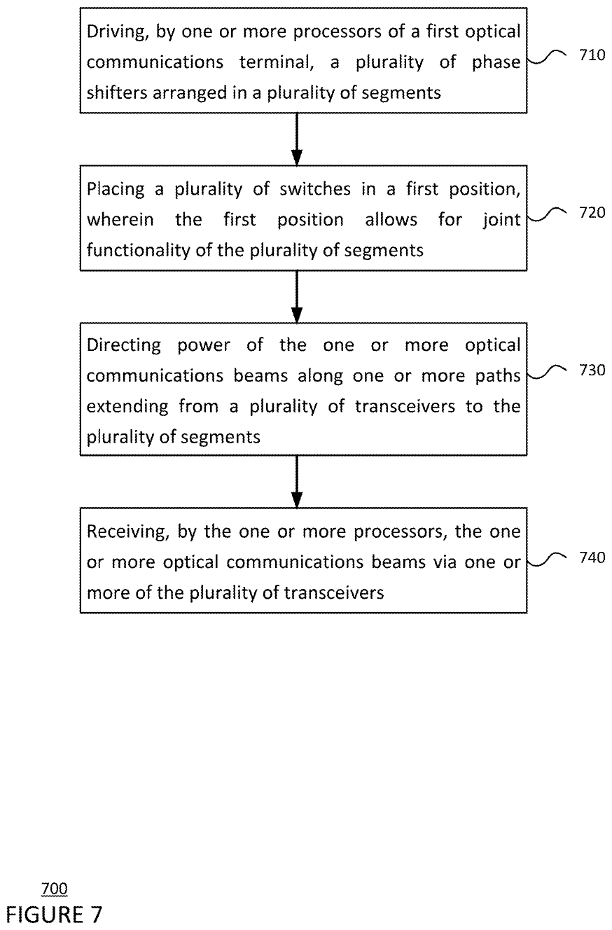

In addition, the plurality of segments may function in conjunction to receive an optical communications beam from a remote optical communications terminal. In this example, light moves through the segments of the segmented OPA architecture in a receive direction. In the receive direction, light may be directed from each the plurality of segments to a transceiver (e.g., the full array transceiver or one of the plurality of segment transceivers). FIG. 7 illustrates an example method 700 of receiving one or more optical communications beams. For example, at block 710, the plurality of phase shifters of the plurality of segments may be driven by one or more processors of a first optical communications terminal. In this regard, the one or more processors 104 of the first optical communications terminal 102 may jointly drive the plurality of segments 502a, 502b, 502c, 502d to achieve a desired pointing direction for the optical communications beam. As described above, the one or more processors 104 may calculate a phase shift for each segment of the segmented OPA architecture to achieve a desired pointing direction for the one or more optical communications beams 20b.

As shown at block 720, the method 700 may further include placing the plurality of switches in a first position, the first position allowing for joint functionality of the plurality of segments. In such instances, the one or more processors 104 of the first optical communications terminal 102 or a human operator at setup may place the plurality of switches 506a, 506b, 506c, 506d in the first position, as described above.

As shown at block 730, the method 700 may further include directing power of the one or more optical communications beams along one or paths extending from the plurality of transceivers to the plurality of segments. In this scenario, power of the one or more optical communications beams 20b received at each of the segments of the segmented OPA architecture may be combined along a plurality of full array paths extending from a full array transmitter to the plurality of the plurality of segments 502a, 502b, 502c, 502d. The power may be combined via one or more splitters. Prior to the one or more splitters, the phase one or more portions of the optical communications beam to be combined may be adjusted. The one or more portions may be adjusted at the one or more additional phase shifters disposed in one or more of the full array paths. The phase adjustment may be such that the one or more portions to be combined are of the correct phase (e.g., in phase when combined) to avoid interference.

As shown in FIG. 5, the first splitter 512a is disposed in the first full array path and the second full array path. In the receive direction, the first splitter 512a may combine the power from the first full array path and the second full array path into a joint first and second full array path. The first additional phase shifter 510a is disposed in the first full array path on the segment side of the first splitter 512a. The first additional phase shifter 510a may adjust the phase of a first portion of the optical communications beam from the first segment 502a. The first portion may be adjusted such that the phase of the first portion is the same as a second portion of the optical communications beam from the second segment 502b.

In addition, the second splitter 512b is disposed in the third full array path and the fourth full array path. In the receive direction, the second splitter 512b may combine the power from the third full array path and the fourth full array path into a joint third and fourth full array path. The second additional phase shifter 510b is disposed in the third full array path on the segment side of the second splitter 512b. The second additional phase shifter 510b may adjust the phase of a third portion of the optical communications beam from the third segment 502c. The third portion may be adjusted such that the phase of the third portion is the same as a fourth portion of the optical communications beam from the fourth segment 502d.

In addition, the third splitter 512c is disposed in the first full array path, second full array path, third full array path, and fourth full array path. In the receive direction, the third splitter 512c may combine the joint first and second full array path and the joint third and fourth full array path into a joint first, second, third, and fourth full array path. The third additional phase shifter 510c is disposed in the joint first and second full array path on the segment side of the third splitter 512c. The third additional phase shifter 510c may adjust the phase of the combined first and second portions of the optical communications beam from the first and second segments 502a, 502b. The combined first and second portions may be adjusted such that the phase of the combined first and second portions is the same as the combined third and fourth portions of the optical communications beam from the third and fourth segments 502c, 502d.

At block 740, the method 700 may further include receiving, by the one or more processors, the one or more optical communications beams via one or more of the plurality of transceivers. The one or more processors 104 of the first optical communications terminal 102 may receive the one or more optical communications beams 20b via all of the plurality of segments 502a, 502b, 502c, 502d of the OPA at once or rather via the full array transceiver. For instance, referring to FIG. 5, the first segment 502a, the second segment 502b, the third segment 502c, and the fourth segment 502d may be used to receive one or more optical communications beams 20b via the full array transceiver 514. Using the one or more optical communication beams, the one or more processors 104 may establish a communication link with the remote optical communications terminal or transfer data.

In another scenario, one or more of the plurality of segments of the segmented OPA architecture may function independently to transmit and receive optical communications beams.

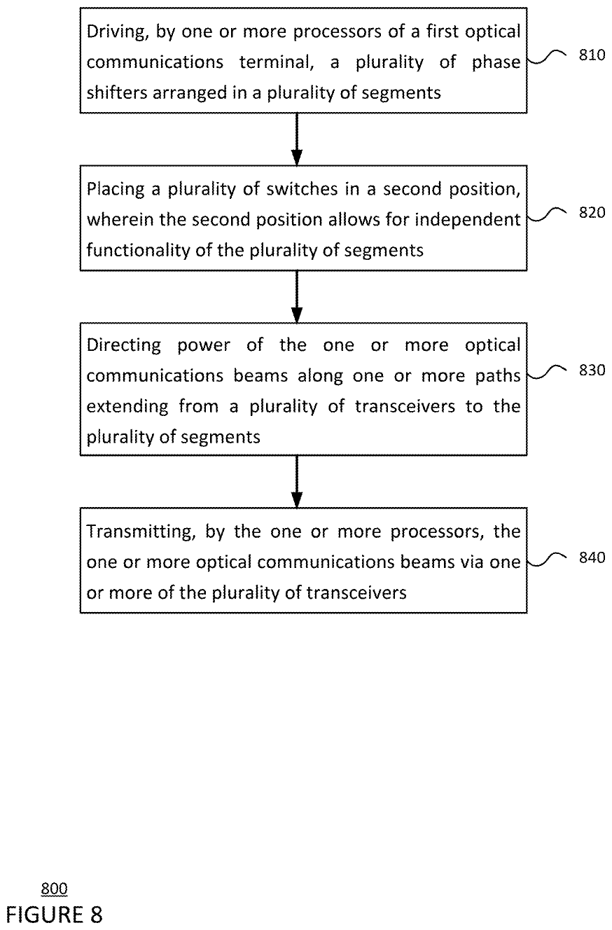

For instance, all of the plurality of segments may be independently driven to each transmit one or more optical communications beams to a different remote optical communications terminal of a plurality of remote optical communications terminals. The individual segments of the segmented OPA architecture may transmit one or more optical communications beams to differing remote terminals at differing times or simultaneously. For example, for an optical communications terminal with four segments, each of the four segments may be independently driven to transmit one or more optical communications beams to a remote optical communications terminal or client device. In this regard, the optical communications terminal with four segments may transmit one or more optical communications beams to each of the four remote optical communications terminals or client devices. The optical communications terminal with four segments may transmit one or more optical communications beams to each of the four terminals at differing times or simultaneously. FIG. 8 illustrates an example method 800 of transmitting one or more optical communications beams. For example, at block 810, the plurality of phase shifters of the plurality of segments may be driven by one or more processors of a first optical communications terminal. In this regard, the one or more processors 104 of the first optical communications terminal 102 may separately drive each of the plurality of segments 502a, 502b, 502c, 502d. The plurality of segments 502a, 502b, 502c, 502d may be driven to achieve a plurality of desired pointing directions for each of the plurality remote optical communications terminals or client devices. In this regard, the one or more processors 104 may calculate a phase shift for each individual segment of the plurality of segments of the segmented OPA architecture to achieve the plurality desired pointing directions for the one or more optical communications beams 20a. For instance, the one or more processors 104 may determine a shift for each phase shifter in each of the segments of the segmented OPA architecture based on the desired pointing directions.

The one or more processors 104 may determine a desired pointing direction for the one or more optical communications beams 20a based on a location of each remote optical communications terminal relative to the position of the aperture 214 of the first optical communications terminal. For example, the desired pointing directions may be an angular value such as 2 degrees, −5 degrees, etc. from an axis of aperture 214 of the first optical communications terminal 102. In some implementations, the location of the remote optical communications terminal may be a predefined location of the remote optical communications terminal that can be provided during setup of the communications system.

Additionally or alternatively, the one or more processors 104 of the first optical communications terminal 102 may predict or determine the location of each remote optical communications terminal based on characteristics of one or more signals (e.g., beacon signals) received from each remote optical communications terminal during acquisition. The one or more processors 104 may receive the one or more signals while conducting a raster-scan across the FOR of the first optical communications terminal 102. In this regard, the terminals of the optical communications system may coordinate acquisition and broadcasting states such that the first optical communications terminal 102 may receive one or more signals from each remote optical communications terminal.

In one example, the signal received from the remote optical communications terminal may be a beacon signal from a raster-scan of the remote optical communications terminal. In another example, the signal received from the remote optical communications terminal may be a divergent beam covering the FOR of the remote optical communication terminal.

As shown at block 820, the method 800 may further include placing the plurality of switches in a second position, the second position allowing for independent functionality of the plurality of segments. In such an instance, the one or more processors 104 of the first optical communications terminal 102 may place the plurality of switches 506a, 506b, 506c, 506d in the second position upon receipt of one or more beacon signals from each remote optical communications terminal. Additionally or alternatively, a human operator at setup may place the plurality of switches 506a, 506b, 506c, 506d in the second position. In the second position, the plurality of segments 502a, 502b, 502c, 502d may function independently (i.e., be driven separately to transmit and receive optical communications beams). For instance, referring to FIG. 5, when the first switch 506a, second switch 506b, third switch 506c, and fourth switch 506d are in the second position, the first segment 502a, second segment 502b, third segment 502c, and fourth segment 502d may function independently.

As shown at block 830, the method 800 may further include directing power of the one or more optical communications beams along one or paths extending from the plurality of transceivers to the plurality of segments. In this scenario, power of the one or more optical communications beams 20a may be directed along a plurality of segment paths from a plurality of segment transceivers to the plurality of the plurality of segments 502a, 502b, 502c, 502d. For instance, referring to FIG. 5, each of the first segment transceiver 508a, second segment transceiver 508b, third segment transceiver 508c, and fourth segment transceiver 508d may direct power individually via the plurality of segment paths to each of the corresponding segments.

At block 840, the method 800 may further include transmitting, by the one or more processors, the one or more optical communications beams via one or more of the plurality of transceivers. The one or more processors 104 may transmit the one or more optical communications beams 20a via a corresponding one of the plurality of segment transceivers. For instance, referring to FIG. 5, the first segment 502a, the second segment 502b, the third segment 502c, and the fourth segment 502d may be used to transmit one or more optical communications beams 20a via the first segment transceiver 508a, second segment transceiver 508b, third segment transceiver 508c, and fourth segment transceiver 508d respectively. Using the one or more optical communication beams, the one or more processors 104 may establish a communication link with a different remote optical communications terminal or transfer data. In some implementations, one or more communications beams may be transmitted by each segment at differing times or simultaneously.

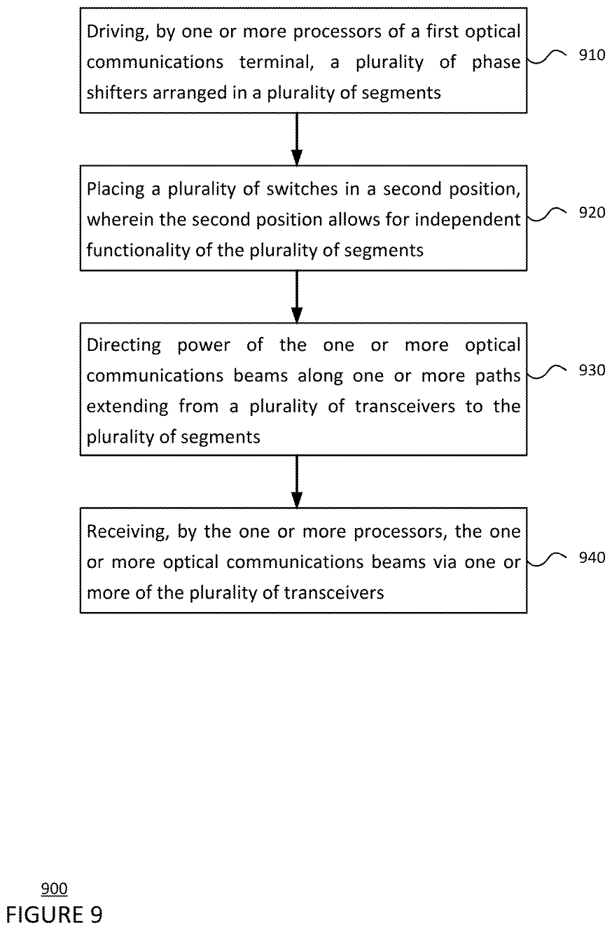

In addition, all of the plurality of segments may be independently driven to each receive one or more optical communications beams from a different remote optical communications terminal at different locations. The individual segments of the segmented OPA architecture may receive optical communications beams from differing remote optical communications terminals at differing times or simultaneously. FIG. 9 illustrates an example method 900 of transmitting one or more optical communications beams. For example, at block 910, the plurality of phase shifters of the plurality of segments may be driven by one or more processors of a first optical communications terminal. In this regard, the one or more processors 104 of the first optical communications terminal 102 may separately drive each of the plurality of segments 502a, 502b, 502c, 502d to achieve a plurality of desired pointing directions for each of the plurality remote optical communications beams. In this regard, the one or more processors may calculate a phase shift matrix for each segment of the segmented OPA architecture to achieve the plurality desired pointing directions for the one or more optical communications beams 20b as described above.

As shown at block 920, the method 900 may further include placing the plurality of switches in a second position, the second position allowing for independent functionality of the plurality of segments. In such instances, the one or more processors 104 of the first optical communications terminal 102 or a human operator at setup may place the plurality of switches 506a, 506b, 506c, 506d in the second position, as described above.

As shown at block 930, the method 900 may further include directing power of the one or more optical communications beams along one or paths extending from the plurality of transceivers to the plurality of segments. In this scenario, power of the one or more optical communications beams 20b may be directed along a plurality of segment paths extending from a plurality of segment transceivers to the plurality of the plurality of segments 502a, 502b, 502c, 502d. For instance, referring to FIG. 5, the plurality of segment transceivers includes first segment transceiver 508a, second segment transceiver 508b, third segment transceiver 508c, and fourth segment transceiver 508d corresponding to a first segment 502a, second segment 502b, third segment 502c, and fourth segment 502d. In this regard, each transceiver may receive power individually from each of the corresponding segments via the plurality of segment paths.

At block 940, the method 900 may further include receiving, by the one or more processors, the one or more optical communications beams via one or more of the plurality of transceivers. In this scenario, the one or more processors 104 of the first optical communications terminal 102 may receive the one or more optical communications beams 20b via the plurality of segment transceivers 508a, 508b, 508c, 508d. For instance, referring to FIG. 5, the first segment 502a, the second segment 502b, the third segment 502c, and the fourth segment 502d may be used to receive one or more optical communications beams 20b via the first segment transceiver 508a, second segment transceiver 508b, third segment transceiver 508c, and fourth segment transceiver 508d respectively. Using the optical communication beams, the one or more processors may establish a communication link with each remote optical communications terminal or transfer data. In some implementations, each of the optical communications beams may be received at differing times or simultaneously.

The features and methodology described herein may provide a communication system containing optical communications terminals able to be aligned with one or more remote optical combinations terminals or a plurality of remote optical communications terminals simultaneously. Such a communication system allows for continuous connectivity among a plurality of communications terminals with fewer total optical communications terminals. Moreover, the communication of one remote optical communications terminal with either one or multiple remote optical communications terminals allows for the communication system to form a Mesh-Network Architecture, which is highly advantageous for deployment and communications efficiency. As such, one optical communications terminal may function as a node within the system. In this regard, such communication systems require less materials to construct and are easier to maintain overall.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. An optical communications terminal comprising:
an optical phased array (OPA) photonic integrated chip comprising:
a plurality of phase shifters arranged in a plurality of segments;
one or more additional phase shifters,
a plurality of switches corresponding to each of the plurality of segments; and
one or more splitters;
a full array transceiver configured to allow for transmission and receipt of optical communications beams functionality with the plurality of segments; and
a plurality of segment transceivers each associated with one of the plurality of segments.

2. The optical communications terminal of claim 1, further comprising one or more paths extending from one or more of the full array transceivers and the plurality of the segment transceivers to the plurality of segments.

3. The optical communications terminal of claim 2, wherein the one or more paths include a plurality of full array paths and a plurality of segment paths, the plurality of full array paths extending from the full array transceiver to each of the plurality of segments, and the plurality of segment paths extending from each of the plurality of segment transceivers to each corresponding segment of the plurality of segments.

4. The optical communications terminal of claim 3, wherein the one or more additional phase shifters are disposed in at least one of the plurality of full array paths.

5. The optical communications terminal of claim 3, wherein the one or more splitters are disposed in at least one of the plurality of full array paths.

6. The optical communications terminal of claim 3, wherein the plurality of switches are disposed in one of the plurality of full array paths and one of the plurality of segment paths.

7. The optical communications terminal of claim 1, wherein each of the plurality of segments includes a waveguide configuration, the waveguide configuration comprising:
one or more combiners; and
an edge coupler;
wherein the one or more combiners and edge coupler are connected via waveguides.

8. A method of transmitting one or more optical communications beams comprising:
driving, by one or more processors of a first optical communications terminal, a plurality of phase shifters arranged in a plurality of segments;
placing a plurality of switches in one of i) a first position or ii) a second position, wherein the first position allows for joint functionality of the plurality of segments and wherein the second position allows for independent functionality of the plurality of segments;
directing power of the one or more optical communications beams along one or more paths extending from a plurality of transceivers to the plurality of segments; and
transmitting, by the one or more processors, the one or more optical communications beams via one or more of the plurality of transceivers.

9. The method of claim 8, wherein placing a plurality of switches in one of i) the first position or ii) the second position is conducted during setup of the first optical communications terminal.

10. The method of claim 8, wherein placing a plurality of switches in one of i) the first position or ii) the second position is conducted following receipt of one or more beacon signals from one or more remote optical communications terminals.

11. The method of claim 8, further comprising, determining, by the one or more processors, a desired pointing direction for the one or more optical communications beams based on one or more locations corresponding to one or more remote devices.

12. The method of claim 11, wherein the one or more locations of the one or more remote devices are provided predefined locations.

13. The method of claim 11, further comprising determining the one or more locations of the one or more remote devices based on characteristics of one or more received from the one or more remote devices during acquisition.

14. The method of claim 8, wherein:
the plurality of switches are placed in the first position;
the plurality of transceivers includes a full array transceiver configured to allow for transmission of optical communications beams functionality with the plurality of segments;
the one or more paths include a plurality of full array paths, the plurality of full array paths extending from the full array transceiver to each of the plurality of segments; and
directing power of the one or more optical communications beams along one or more paths extending from a plurality of transceivers to the plurality of segments includes:
dividing power along the plurality of full array paths using one or more splitters.

15. The method of claim 14, wherein transmitting, by the one or more processors, the one or more optical communications beams via one or more of the plurality of transceivers includes:
transmitting, by the one or more processors, the one or more optical communications beams via the full array transceiver.

16. The method of claim 8, wherein:
the plurality of switches are placed in the second position;
the plurality of transceivers includes a plurality of segment transceivers each associated with one of the plurality of segments;
the one or more paths include a plurality of segment paths, the plurality of segment paths extending from each of the plurality of segment transceivers to each corresponding segment of the plurality of segments; and
directing power of the one or more optical communications beams along one or more paths extending from a plurality of transceivers to the plurality of segments includes:
directing power along the plurality of segment paths.

17. The method of claim 16, wherein transmitting, by the one or more processors, the one or more optical communications beams via one or more of the plurality of transceivers includes:
transmitting, by the one or more processors, the one or more optical communications beams via one or more of the plurality of segment transceivers.

18. A method of receiving one or more optical communications beams comprising:
driving, by one or more processors of a first optical communications terminal, a plurality of phase shifters arranged in a plurality of segments;
placing, by the one or more processors, a plurality of switches in one of i) a first position or ii) a second position, wherein the first position allows for joint functionality of the plurality of segments and wherein the second position allows for independent functionality of the plurality of segments;
directing power of the one or more optical communications beams along one or more paths extending from a plurality of transceivers to the plurality of segments; and
receiving, by the one or more processors, the one or more optical communications beams via one or more of the plurality of transceivers.

19. The method of claim 18, wherein placing a plurality of switches in one of i) the first position or ii) the second position is conducted during setup of the first optical communications terminal.

20. The method of claim 18, wherein placing a plurality of switches in one of i) the first position or ii) the second position is conducted following receipt of one or more beacon signals from one or more remote optical communications terminals.

21. The method of claim 18, wherein:
the plurality of switches are placed in the first position;
the plurality of transceivers includes a full array transceiver configured to allow for receipt of optical communications beams functionality with the plurality of segments;
the one or more paths include a plurality of full array paths, the plurality of full array paths extending from the full array transceiver to each of the plurality of segments; and
directing power of the one or more optical communications beams along one or more paths extending from a plurality of transceivers to the plurality of segments includes:
combining power along the plurality of full array paths using one or more splitters,
adjusting a phase of at least one portion of the one or more optical communications beams along at least one of the plurality of full array paths using on or more additional phase shifters.

22. The method of claim 21, wherein receiving, by the one or more processors, the one or more optical communications beams via one or more of the plurality of transceivers includes:
receiving, by the one or more processors, the one or more optical communications beams via the full array transceiver.

23. The method of claim 18, wherein:
the plurality of switches are placed in the second position;
the plurality of transceivers includes a plurality of segment transceivers each associated with one of the plurality of segments;
the one or more paths include a plurality of segment paths, the plurality of segment paths extending from each of the plurality of segment transceivers to each corresponding segments of the plurality of segments; and
directing power of the one or more optical communications beams along one or more paths extending from a plurality of transceivers to the plurality of segments includes:
directing power along the plurality of segment paths.

24. The method of claim 23, wherein receiving, by the one or more processors, the one or more optical communications beams via one or more of the plurality of transceivers includes:
receiving, by the one or more processors, the one or more optical communications beams via one or more of the plurality of segment transceivers.
